(19) United States
(12) Patent Application Publication
(10) Pub. No.: US 2015/0211254 A1
(43) Pub. Date: Jul. 30, 2015

(54) CYLINDER CASING OF A LOCKING DEVICE

(71) Applicant: ESSEC AB, Stockholm (SE)

(72) Inventor: Jimmy Hesselbäck, Stockholm (SE)

(73) Assignee: ESSEC AB, Stockholm (SE)

(21) Appl. No.: 14/400,804

(22) PCT Filed: May 15, 2013
(86) PCT No.: PCT/SE2013/050546

§ 371 Date: Nov. 13, 2014

(30) Foreign Application Priority Data
May 15, 2012 (SE) 1250498-1

(51) Int. Cl. E05B 9/04

(52) U.S. Cl. CPC E05B 9/04

(57) ABSTRACT

Cylinder casing connected to a doorplate of a locking device, which cylinder casing is provided with a neck formed to extend through a circularly shaped cylinder casing recess, which is arranged in the doorplate and in which the cylinder casing is mounted, wherein the cylinder casing can rotate in the cylinder casing recess in relation to the doorplate, but that a rotation-preventing break device is arranged between the doorplate and the cylinder casing to prevent such a rotation.

### TECHNICAL FIELD

The present invention relates to the field of locking and particularly to a strengthening of a cylinder casing to eliminate impact on the cylinder casing in an attempted burglary.

### BACKGROUND OF THE INVENTION

The background of the invention is conventional cylinder casings that are bolted from the inside of the door, wherein cylinder casings clamp doorplates to a locking device, when doorplates are mounted. These cylinder casings risk a breaking action in order to expose the lock cylinder of the lock that are placed inside the cylinder casing so as to thereby also break up the lock cylinder and force the door. Thus, the cylinder casing is there to protect the lock cylinder and its mounting in the door.

Should an unauthorised person be able to break off the cylinder casing by applying a puller or the like and pull/rotate it away, the lock cylinder is exposed, which thereby can be forced more easily.

The problem is that an unauthorised person with a conventional design of the cylinder casing and the doorplate can effect entrance by forcing the cylinder casing and lock cylinder.

### THE OBJECT OF THE INVENTION

The object of the invention is to provide a cylinder casing to a lock wherein the above-mentioned problems are eliminated.

The object is furthermore to enable rotation of the cylinder casing in relation to a doorplate upon a breaking action on the cylinder casing.

The object is furthermore to provide a cylinder casing having a security increasing break device wherein the cylinder casing is anchored in a door reinforcement accessory such as a doorplate.

### SUMMARY OF THE INVENTION

By the present invention, as this appears in the independent claim, the above-mentioned objects are met, wherein said disadvantages have been eliminated. Suitable embodiments of the invention are defined in the dependent claims.

The present invention concerns a cylinder casing that is connected to a doorplate of a locking device. The cylinder casing is provided with a neck formed to extend through a circularly shaped cylinder casing recess, which is arranged in the doorplate and in which the cylinder casing is mounted. The cylinder casing is mounted from the inside of the doorplate. The cylinder casing can rotate in the cylinder casing recess in relation to the doorplate but a rotation-preventing break device is arranged between the doorplate and the cylinder casing to prevent such a rotation. The break device may look in many different ways but is dimensioned to resist a predetermined torque between the doorplate and the cylinder casing. The break device may be placed in different positions and also consist of a plurality of break devices. Also the shape of the break device may be varied within the scope of the invention. The neck and the cylinder casing recess may be cylindrically or conically shaped and correspond with each other in diameter for a suitable fit between the parts. Thus, the neck is the part of the cylinder casing that extends through the doorplate and has an outer surface that faces a co-operation surface in a cylinder casing recess in the doorplate. These surfaces facing each other may be cylindrical, conical, or curved.

In one embodiment of the invention, the neck is provided with a mounting ring, the rotation-preventing break device being placed between the doorplate and the mounting ring of the cylinder casing. The function of the mounting ring is to lock the cylinder casing against an axially outwardly directed motion. This object is achieved either by an outer mounting ring or by a recessed mounting ring. Within the scope of this purpose, the geometry of the mounting ring may be shaped as a whole ring or as radially directed protuberances from the cylinder casing. For an embodiment wherein the above mentioned surfaces facing each other are curved, the mounting ring may consist of the externally curved surfaces of the cylinder casing.

In one embodiment of the invention, the cylinder casing recess of the doorplate is provided with a ring-shaped notch in which the mounting ring irrespective of design, when the cylinder casing has been mounted, is contained and can rotate if no rotation-preventing the break device is applied.

In one embodiment of the invention, the inner plane inside of the doorplate is flush with the plane inside of the cylinder casing. This embodiment gives the locking device, i.e., the cylinder casing and the doorplate, a plane design, which may abut entirely plane against the side of a door. Thus, the door side does not have to be adapted for projecting parts from the locking device.

In one embodiment of the invention, the neck is cylindrical for possible rotation in the cylinder casing recess, which also is cylindrically shaped.

In one embodiment of the invention, the cylinder casing comprises a cylindrically shaped cylinder space that is symmetrically placed in the cylinder casing, in which cylinder space an adapter for a lock cylinder can rotate. This embodiment allows the adapter and the lock cylinder mounted therein to be rotationally fixed while the cylinder casing can be rotated.

In the normal case, the adapter, the cylinder casing, and the lockplate are stationary oriented in relation to each other, but if a breaking action from outside on the cylinder casing, by for instance a pipe wrench, in order to demolish the lock in an attempted burglary, the break device will yield and the cylinder casing will only rotate without damaging neither the adapter nor the lock cylinder.

In one embodiment, the cylinder casing comprises an integrated mounting ring provided with a groove. The cylinder casing is entered from the inside of an outer door reinforcement accessory, which corresponds to a doorplate that is formed with special material that can be hardened and has been formed with dimensions and that thereby entails a strengthening of the locking device. In order for the cylinder casing not to end up in involuntary rotation, the groove in the mounting ring of the cylinder casing should be fitted into a corresponding groove in the door reinforcement accessory. In said grooves fitted against each other, a break device in the form of a rotation-preventing shearing pin is pressed in. Upon forceful tampering by trying to rotate the cylinder casing by force in any direction, said pin will break, which results in the cylinder casing being rotatable in an uncontrolled way, which in turn may entail that the one who wants to be able to open the lock with a key after such an action has to rotate the cylinder ring so that the same does not block insertion of a key.

The large advantage of the shearing pin breaking upon torque impact is that the cylinder ring cannot be rotated away by any kind of puller. The large advantage of the clamping mounting ring is that the lock cylinder cannot be uncovered and thereby be rotated away by a puller of any kind, e.g. spanner.

In an alternative embodiment, there is a solid peg, corresponding to the shearing pin, on the mounting ring, which peg is fitted into the groove on the inside of the door reinforcement accessory that also breaks in the corresponding way upon tampering. Preferably, the peg height is approx. 3 mm with a width of approx. 1.5 mm.

In a further alternative embodiment, the cylinder casing is terminated with a cylindrical part between the mounting ring and the diameter of the conical cylinder casing of approx. 5 mm. The same cylindrical part is found on the door reinforcement accessory for fitting in.

The mounting ring is very important to prevent a pulling out of the cylinder ring using special tools from the outside of the door reinforcement accessory.

### BRIEF DESCRIPTION OF THE DRAWINGS

Now, the invention will be described in more detail, reference being made in connection with the accompanying drawing figures.

FIG. 1a shows in perspective a cylinder ring according to the invention.

FIG. 1b shows in perspective the cylinder ring according to the invention from the inside.

FIG. 1c shows in perspective an enlargement of a marked part from FIG. 1a.

FIG. 2 shows in perspective an adapter for a lock cylinder.

FIG. 3 shows in perspective a doorplate for a door lock.

FIG. 4 shows in planar view the doorplate from the inside according to an embodiment of the invention.

FIG. 5 shows an enlargement of a marked part from FIG. 4.

FIG. 6 shows in perspective the cylinder ring according to the invention mounted in the doorplate.

FIG. 7 shows in an upper part of a planar view the mounting according to FIG. 6 from the inside with a marked break device according to the invention.

FIG. 8 shows a first embodiment of a break device according to the invention.

FIG. 9 shows a second embodiment of a break device according to the invention.

FIG. 10 shows a third embodiment of a break device according to the invention.

FIG. 11 shows a fourth and a fifth embodiment of a break device according to the invention.

FIG. 12 shows in enlargement the fourth embodiment in FIG. 11.

FIG. 13 shows in enlargement the fifth embodiment in FIG. 11 and a sixth embodiment according to the invention.

### DESCRIPTION OF THE INVENTION

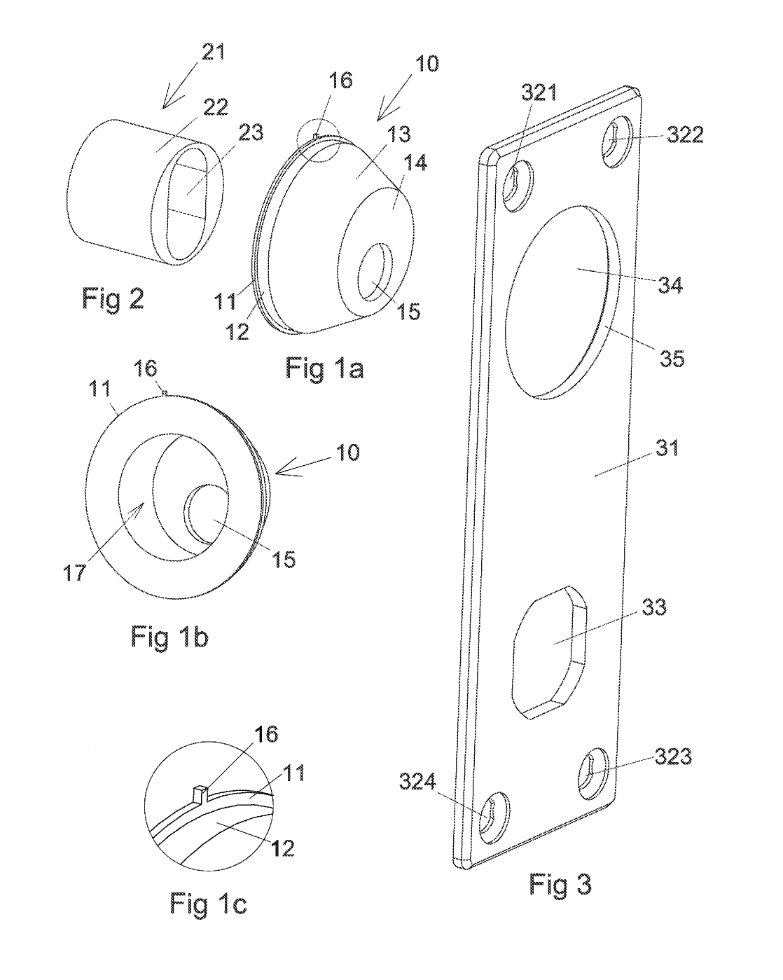

FIG. 1a shows a cylinder casing 10 provided with a mounting ring 11 on the inner end thereof. The mounting ring is fixedly connected with the cylinder casing and formed as a collar that transforms into a cylindrical neck 12 of the cylinder casing 10. The cylindrical neck 12 transforms then outward into a conical part 13 and the outer end of the cylinder casing is formed as an essentially plane circular surface 14 in which a recess 15 for a key insertion is placed. The cylindrical neck 12 may also be conically shaped and co-operate with a corresponding surface in a doorplate. The mounting ring 11 is provided with at least one break device 16 in the form of a break peg integrated in the mounting ring 11. The outer diameter of the mounting ring is greater than the outer diameter of the neck 12 so that the mounting ring 11 creates a fixed axial position for the cylinder casing when the same is mounted.

FIG. 1b shows the cylinder casing 10 from the inside and shows that the cylinder casing is provided with a cylinder space 17 that is cylindrically shaped and placed symmetrically in the cylinder casing 10. The figure also shows the break device 16 as a break peg directed radially outward from the mounting ring 11. The through recess 15 for the key insertion is also shown in the figure.

FIG. 1c shows an enlargement of the break device 16 connected to the mounting ring 11. The break device is formed with a rectangular cross-section, for instance quadratic. Also the cylindrical neck 12 of the cylinder casing is shown in the figure.

FIG. 2 shows an adapter 21 for a lock cylinder. This adapter is formed with a cylindrical outer surface 22 and provided with an inner space 23 for the connection of a lock cylinder, not shown, for a lock.

FIG. 3 shows a doorplate 31 for a lock. The doorplate is formed as a reinforcement accessory of a suitable choice of material and dimension for this purpose. The doorplate 31 is provided with mounting holes 321, 322, 323, 324 and with a handle recess 33. Furthermore, the doorplate is provided with a cylinder casing recess 34 provided with a co-operation surface 35 corresponding to the cylindrical neck.

FIGS. 2, 1a, and 3 are placed as an exploded diagram, which entails that the adapter 21 is mounted in the cylinder space 17 of the cylinder casing 10, the cylinder casing being applied in the cylinder casing recess 34 by abutment against a notch in the doorplate or by abutment directly against the doorplate. In this connection, the adapter is bolted from the inside of the door.

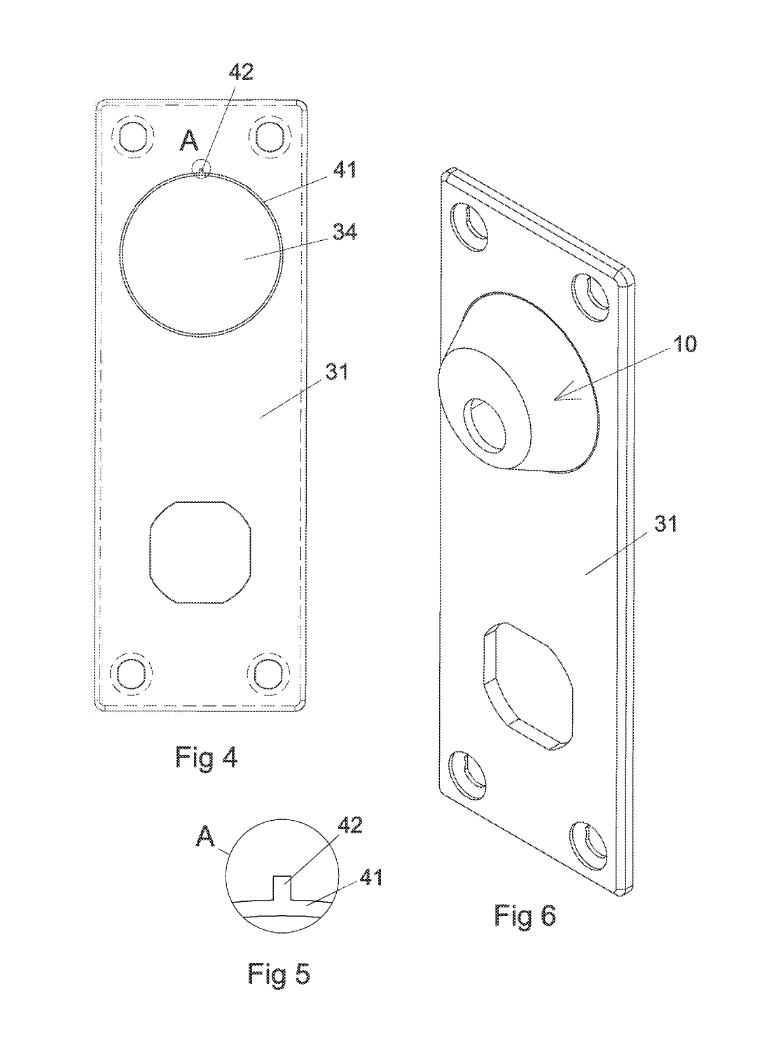

FIG. 4 shows the doorplate 31 from the inside wherein the periphery of the cylinder casing recess 34 is provided with a notch 41, which is formed to co-operate with the mounting ring 11 shown in FIGS. 1a, 1b, and 1c. Furthermore, the notch 41 is formed with a rectangular break recess 42 in the form of a radially directed groove that is formed to co-operate with the break device 16 shown in FIGS. 1a, 1b, and 1c.

FIG. 5 shows an enlargement A from FIG. 4 with the break recess 42 connecting to the notch 41. The design of the break recess 42 is rectangular and oriented peripherally and placed “12 o'clock” at the notch when the doorplate is oriented as shown by FIG. 4. Also other peripheral orientations are equally suitable, and in addition more than one break recess 42 co-operating with each a break device may be placed around the notch 41.

FIG. 6 shows the cylinder casing 10 mounted in the doorplate 31 and how said mounting visually looks from the outside. In this connection, it is seen that the appearance is generally identical with conventional designs of the corresponding locking devices, wherein the visual impression of a device according to the invention accordingly does not deviate from a conventional impression of a corresponding locking device.

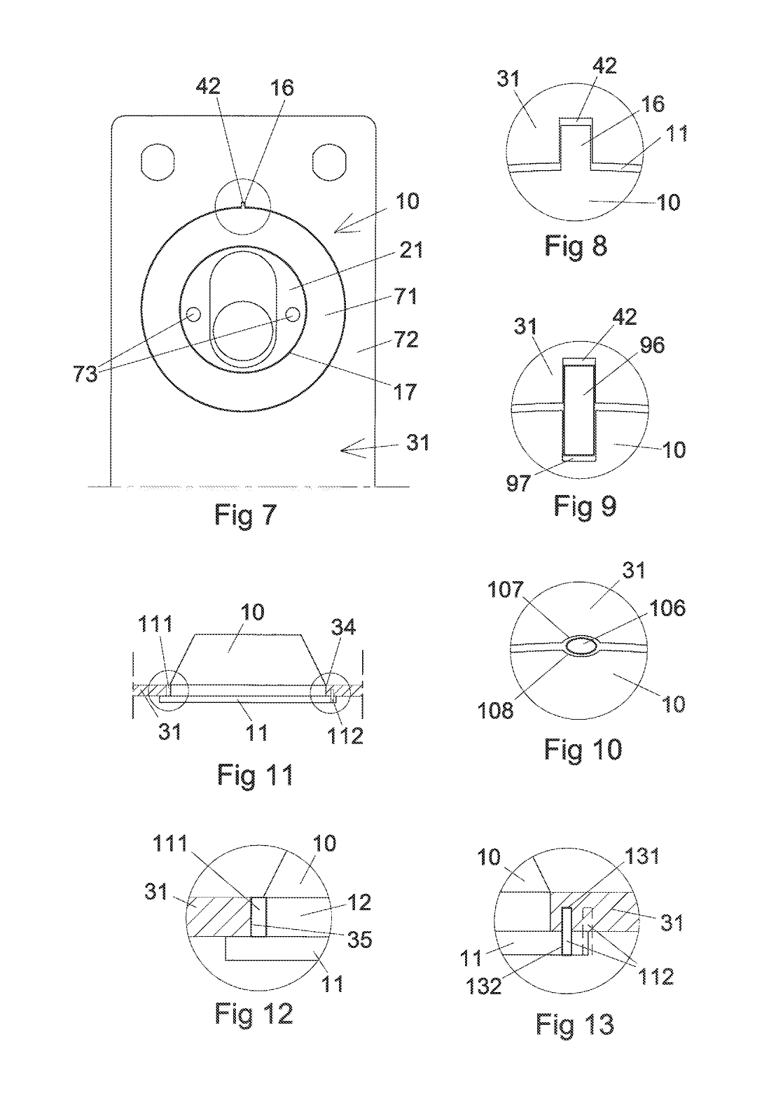

FIG. 7 shows the upper part of the inside/back side of the mounting according to FIG. 6 supplemented with the cylindrically shaped adapter 21 for a lock cylinder mounted in the cylinder space 17. The cylinder casing 10 with its plane inside 71 is mounted in the doorplate 31, the inside 71 being flush with the plane inside 72 of the doorplate 31. As seen in the figure, the cylinder casing 10 is rotationally secured by the break device 16 having been mounted in the break recess 42. The adapter 21 is furthermore provided with threaded holes 73 by which the adapter 21 is anchored in the lock case, not shown.

FIG. 8 shows a first embodiment of a break device according to the invention. This break device 16 is identical with the previously shown break device but shown enlarged and mounted in the break recess 42 in the doorplate 31. In this first embodiment, the break device 16 is fixedly connected to the mounting ring 11 of the cylinder casing 10. In this connection, the break device 16 is dimensioned to be broken by shear on a certain level upon an applied torque between the cylinder casing 10 and the doorplate 31.

By the break device 16 being sheared off, the cylinder casing 10 will rotate in the mounting notch in the doorplate 31, which entails that a breaking action on the outside of the conical part of the cylinder casing, for instance by a pipe wrench, will not destroy the lock. Also the adapter for the lock cylinder will be able to be stationary in the cylinder space upon such a breaking action by the fact that the cylinder casing will rotate around the adapter.

FIG. 9 shows a second embodiment of a break device 96 according to the invention. This break device consists of a separate pin, which has been designed both in dimensions to fit in the break recess 42 in the doorplate 31 and in strength to be sheared off upon a determined torque load on the cylinder casing 10. The break device 96 engages a corresponding rectangular and radially directed break recess 97 in the cylinder casing 10. The break device 96 is secured in the respective break recess 42, 97 either by press fit or by an applied adhesive in the break recesses.

FIG. 10 shows a third embodiment of a break device 106 according to the invention. This break device 106 consists of a separate shear means being in the form of an elliptical cushion, which, for instance, may be formed as a welding bead having a determined breaking load. It may also be formed from alternative materials such as polymers or rubber, a break providing a rotation at high friction between the cylinder casing 10 and the doorplate 31. In this embodiment, the break recess 107 in the doorplate 31 and the break recess 108 in the cylinder casing 10 are formed as curve-shaped indentations. Said break recesses may together also be circularly shaped, wherein the break device may consist of a screw that has been screwed into the doorplate 31.

FIG. 11 shows a fourth and a fifth embodiment of a break device between the cylinder casing 10 and the doorplate 31. In a fourth embodiment, the break device 111 is formed as a pin of a soft material, such as aluminium or brass, inserted between the cylinder casing 10 and the cylinder casing recess 34. In a fifth embodiment, the break device 112 is formed as a pin between the doorplate 31 and the mounting ring 11, which in the figure is shown as an outer mounting ring.

FIG. 12 shows in a first enlargement from FIG. 11 the fourth embodiment having the break device 111 placed between the neck 12 of the cylinder casing 10 and the co-operation surface 35 of the doorplate 31. In this embodiment, the neck 12 and the co-operation surface 35 are modified to accommodate the break device 111. The embodiment comprises that the break device 111 either may be loose in relation to the mounting ring 11 or be attached to the same in order to be fitted into the modified space between the neck 12 and the co-operation surface 35.

FIG. 13 shows in a second enlargement from FIG. 11 the fifth embodiment having the break device 112 placed between the mounting ring 11 of the cylinder casing 10 and the doorplate 31. The mounting of the break device 112 is effected by the break device 112 being applied in a bottom hole 131 in the doorplate and then by a hole 132, through-going or as a bottom hole, in the mounting ring 11 being fitted in against the break device 112.

This embodiment shown in FIG. 13 may also be modified into a sixth embodiment by the break device 112 being placed in a peripheral recess of the mounting ring, shown in FIG. 13 as a dashed break device 112.

As has been indicated above, the material of the break device in the different embodiments is selected to allow rupture at a suitable load. Suitable materials for the break devices are aluminium or brass. Also steel is suitable if the diameters are relatively small.

Within the scope of the invention, the design of the break recesses as well as the break devices may be varied to provide for the desired effect, viz. in order to, upon a certain load, allow the cylinder casing to rotate in relation to the doorplate.

Both the mounting ring and the notch of the cylinder casing recess are circularly shaped for the mounting ring to be rotatable in the notch should the break device be broken.

1. Cylinder casing connected to a doorplate of a locking device, which cylinder casing is provided with a neck formed to extend through a circularly shaped cylinder casing recess, which is arranged in the doorplate and in which the cylinder casing is mounted, wherein the cylinder casing can rotate in the cylinder casing recess in relation to the doorplate, but that a rotation-preventing break device is arranged between the doorplate and the cylinder casing to prevent such a rotation.

2. Cylinder casing according to claim 1, wherein the neck is provided with a mounting ring, the rotation-preventing break device being arranged between the doorplate and the mounting ring of the cylinder casing.

3. Cylinder casing according to claim 2, wherein the cylinder casing recess of the doorplate is provided with a ring-shaped notch in which the mounting ring, when the cylinder casing has been mounted, is contained.

4. Cylinder casing according to claim 3, wherein the inner plane inside of the doorplate is flush with the plane inside of the cylinder casing.

5. Cylinder casing according to claim 1, wherein the neck is cylindrical for possible rotation in the cylinder casing recess, which also is cylindrically shaped.

6. Cylinder casing according to claim 1, wherein the cylinder casing comprises a cylindrically shaped cylinder space that is symmetrically placed in the cylinder casing so that the cylinder casing can rotate in relation to the adapter.
